(19) United States
(12) Patent Application Publication
(10) Pub. No.: US 2013/0094516 A1
(43) Pub. Date: Apr. 18, 2013

(54) Control Protocol System

(71) Applicants: Ryuji Wakikawa, Mountain View, CA (US); Romain Kuntz, Menlo Park, CA (US); Surjya Sarathi Ray, Rochester, NY (US)

(72) Inventors: Ryuji Wakikawa, Mountain View, CA (US); Romain Kuntz, Menlo Park, CA (US); Surjya Sarathi Ray, Rochester, NY (US)

(73) Assignees: TOYOTA INFOTECHNOLOGY CENTER CO., LTD., Tokyo (JP); TOYOTA JIDOSHA KABUSHIKI KAISHA, Toyota City (JP)

(21) Appl. No.: 13/421,585

(22) Filed: Mar. 15, 2012

Related U.S. Application Data
(60) Provisional application No. 61/548,002, filed on Oct. 17, 2011.

(51) Int. Cl. H04J 3/00

(52) U.S. Cl. 370/443; 370/442

(57) ABSTRACT

A system and method for borrowing one or more time slots for data transmission is disclosed. The system comprises a monitor module, a request module and an allocation module. The monitor module detects a trigger event for borrowing a time slot from a potential lender. The request module generates a borrowing request responsive to the trigger event. The allocation module receives a response responding to the borrowing request from the potential lender. The allocation module determines whether the borrowing request is approved based at least in part on the response. Responsive to an approval of the borrowing request, the allocation module allocates one or more designated time slots included in a first active period and the borrowed time slot included in a second active period for data communication.

### CROSS REFERENCE TO RELATED APPLICATIONS

This application claims priority under 35 USC §119(e) to U.S. Application No. 61/548,002, entitled “Control Protocol System” filed Oct. 17, 2011, the entirety of which is herein incorporated by reference.

### BACKGROUND

The specification relates to data communication systems. In particular, the specification relates to a system and method for managing time slots for data communication using Time Division Multiple Access (TDMA)-based medium access control protocols in an in- vehicle network.

When multiple TDMA-based personal area network (PAN) systems operate on a common channel for data transmission, existing solutions only allow nodes comprised within a PAN system to transmit data during an active period designated for the PAN system. For example, existing solutions do not allow any node comprised within a PAN system to transmit data outside the active period designated for the PAN system in order to avoid interferences and/or collisions among various PAN systems sharing the same channel.

However, under some circumstances that one or more nodes comprised within a PAN system have a bulk of data to send, existing solutions may lead to severe transmission delays because the one or more nodes have to wait and are only allowed to transmit data during the active period designated for the PAN system. Existing solutions may also increase data losses especially when data buffers for a PAN system are full. For example, existing solutions may drop any newly received data packets if the data buffer is full, which frequently results in poor packet delivery ratio. Furthermore, when a node comprised within a PAN system generates data packets outside the active period of the PAN system, existing solutions may buffer the data packets temporarily in a data buffer, causing severe one-hop delays for the delivery of the data packets.

In the case of the IEEE 802.15.4 protocol, which uses a TDMA-based method for its guaranteed-time-slot scheme, existing solutions only consider allocating the guaranteed time slots within a PAN system. For example, existing solutions fail to consider distributing the guaranteed time slots on demand among multiple PAN systems. As a result, existing solutions frequently incur undesirable inefficiency for data transmission. An example cause of this inefficiency is that one or more guaranteed time slots for a first PAN system are frequently wasted if the first PAN system does not have any data to transmit at the guaranteed time slots. Even though a second PAN system has data waiting for transmission, this second PAN system is not allowed to use the idle guaranteed time slots designated for the first PAN system to transmit data. As a result, these existing solutions operate inefficiently.

### SUMMARY OF THE INVENTION

The specification overcomes the deficiencies and limitations of the prior art at least in part by providing a system and method for managing time slots for data communication. The system comprises a monitor module, a request module and an allocation module. The monitor module detects a trigger event for borrowing a time slot from a potential lender. The request module generates a borrowing request responsive to the trigger event. The allocation module receives a response responding to the borrowing request from the potential lender. The allocation module determines whether the borrowing request is approved based at least in part on the response. Responsive to an approval of the borrowing request, the allocation module allocates one or more designated time slots included in a first active period and the borrowed time slot included in a second active period for data communication.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a high-level block diagram illustrating a system for managing time slots for data communication according to one embodiment.

FIG. 2 is a block diagram illustrating a connection unit according to one embodiment.

FIGS. 3A and 3B are event diagrams illustrating a process for managing time slots for data communication according to various embodiments.

FIG. 4 is a flowchart illustrating a method for borrowing one or more time slots for data transmission according to one embodiment.

FIG. 5 is a flowchart illustrating a method for determining whether to lend one or more time slots according to one embodiment.

FIGS. 6A and 6B are graphical representations illustrating a process for managing time slots for data communication according to various embodiments.

FIGS. 7A and 7B are graphical representations illustrating a performance for a time-slot management according to various embodiments.

### DETAILED DESCRIPTION OF THE PREFERRED EMBODIMENTS

A system and method for managing time slots for data communication is described below. In the following description, for purposes of explanation, numerous specific details are set forth in order to provide a thorough understanding of the specification. It will be apparent, however, to one skilled in the art that the embodiments can be practiced without these specific details. In other instances, structures and devices are shown in block diagram form in order to avoid obscuring the specification. For example, the specification is described in one embodiment below with reference to user interfaces and particular hardware. However, the description applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, compact disc read-only memories (CD-ROMs), magnetic disks, read-only memories (ROMs), random access memories (RAMs), erasable programmable read-only memories (EPROMs), electrically erasable programmable read-only memories (EEPROMs), magnetic or optical cards, flash memories including universal serial bus (USB) keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. A preferred embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the various embodiments as described herein.

### System Overview

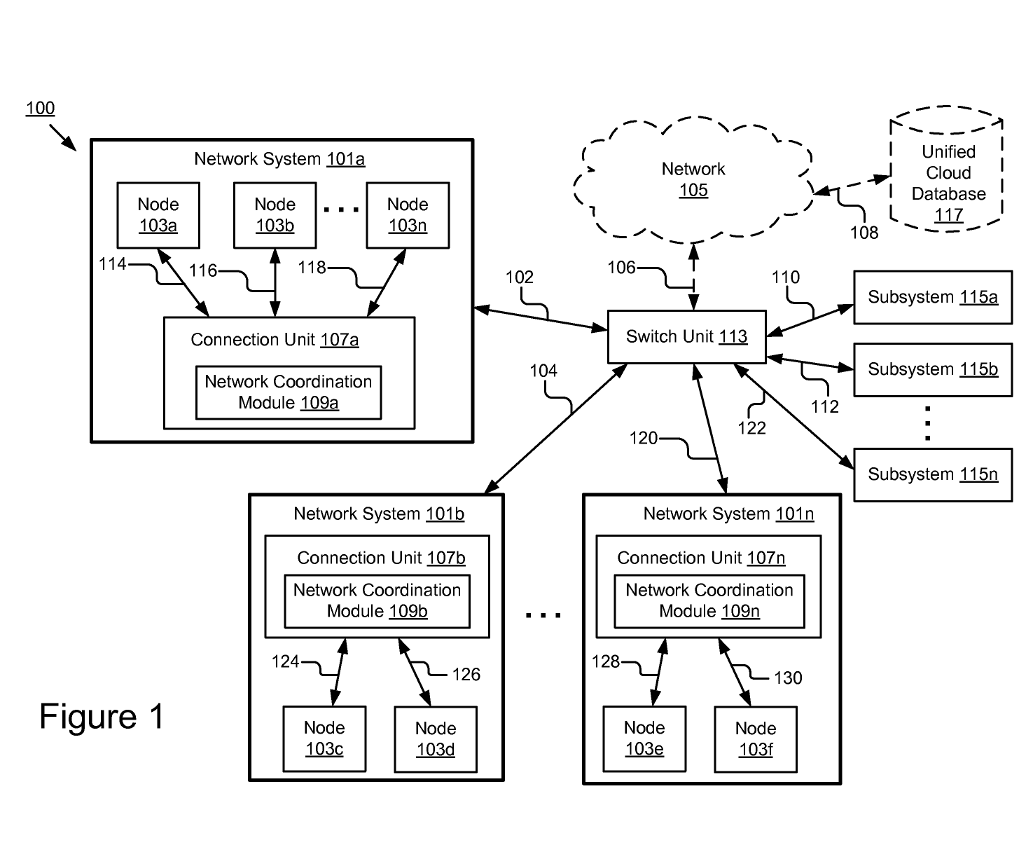

FIG. 1 illustrates a high-level block diagram of a system 100 for managing time slots according to one embodiment. The system 100 includes one or more network systems 101a, 101b . . . 101n (referred to individually or collectively as network system 101), a switch unit 113 and one or more subsystems 115a, 115b . . . 115n (referred to individually or collectively as subsystem 115). These components of the system 100 are communicatively coupled to each other. Although only three network systems 101a, 101b, 101n and three subsystems 115a, 115b, 115n are illustrated, one skilled in the art will recognize that any number of network systems 101 and any number of subsystems 115 may be included in the system 100. Furthermore, while only one switch unit 113 is depicted in FIG. 1, the system 100 could include any number of switch units 113.

The network system 101a is communicatively coupled to the switch unit 113 via signal line 102. The network system 101b is communicatively coupled to the switch unit 113 via signal line 104. The network system 101n is communicatively coupled to the switch unit 113 via signal line 120. The subsystem 115a is communicatively coupled to the switch unit 113 via signal line 110. The subsystem 115b is communicatively coupled to the switch unit 113 via signal line 112. The subsystem 115n is communicatively coupled to the switch unit 113 via signal line 122. In one embodiment, each of signal lines 102, 104, 110, 112, 120 and 122 represents one of a wireless connection (e.g., a wireless local area network (LAN) connection, a Bluetooth® connection, etc.) and a wired connection (e.g., a wired connection via a cable, a landline, etc.).

In the illustrated embodiment, the system 100 further comprises a network 105 and a unified cloud database 117. The network 105 and the unified cloud database 117 are depicted using dashed lines to indicate that they are optional features of the system 100. The switch unit 113 is communicatively coupled to the network 105 via signal line 106. The unified cloud database 117 is communicatively coupled to the network 105 via signal line 108. In one embodiment, each of signal lines 106 and 108 is one of a wireless connection (e.g., a wireless LAN connection, a 3G or 4G network connection, etc.) and a wired connection.

Although the system 100 is illustrated using a star configuration as shown in FIG. 1, in other embodiments the system 100 may be implemented using any other configurations such as a serial bus configuration, token ring configuration or other configurations known to those skilled in the art.

The network system 101a is a system including one or more entities that forms a common network. For example, the network system 101a is a personal area network (PAN) system including a group of devices that form a common personal area network. In the illustrated embodiment, the network system 101a comprises, among other things, one or more nodes 103a, 103b . . . 103n (referred to individually or collectively as node 103) and a connection unit 107a. In one embodiment, the nodes 103a, 103b . . . 103n and the connection unit 107a form a personal area network. In another embodiment, the nodes 103a, 103b . . . 103n and the connection unit 107a form another type of network such as a local area network. These components of the network system 101a are communicatively coupled to each other.

The node 103a is communicatively coupled to the connection unit 107a via signal line 114. The node 103b is communicatively coupled to the connection unit 107a via signal line 116. The node 103n is communicatively coupled to the connection unit 107a via signal line 118. Each of signal lines 114, 116 and 118 is one of a wired connection and a wireless connection such as a Bluetooth® connection.

The nodes 103a, 103b . . . 103n are any devices included in a vehicle. For example, a node 103 is one of a lamp, a motor, a heater, a sensor, an actuator, an electronic control unit (“ECU”), etc. One skilled in the art will recognize that other types of nodes 103 are possible. In one embodiment, a first node 103a communicates with a second node 103b comprised within a common network system 101a via a connection unit 107a. For example, a first node 103a transmits data to the connection unit 107a, causing the connection unit 107a to relay the data to a second node 103b. In another embodiment, a first node 103a communicates with a second node 103b directly without involving the connection unit 107a. For example, a first node 103a communicates with a second node 103b using a Bluetooth® connection.

The connection unit 107a is a module that handles communication for the nodes 103a, 103b . . . 103n comprised within the network system 101a. For example, the connection unit 107a is one of a switch and/or a gateway device, etc. In one embodiment, the connection unit 107a handles communication among the nodes 103a, 103b . . . 103n. For example, the connection unit 107a relays data from a first node 103a to a second node 103b. In another embodiment, the connection unit 107a handles communication between a node 103 in the network system 101a and other components of the system 100. For example, the connection unit 107a receives data from a node 103 comprised within the network system 101a and sends the data to another node 103 comprised within another network system 101. In yet another embodiment, the connection unit 107a is a node 103 comprised within the network system 101a and handles communication associated with all the other nodes 103 comprised within the same network system 101a.

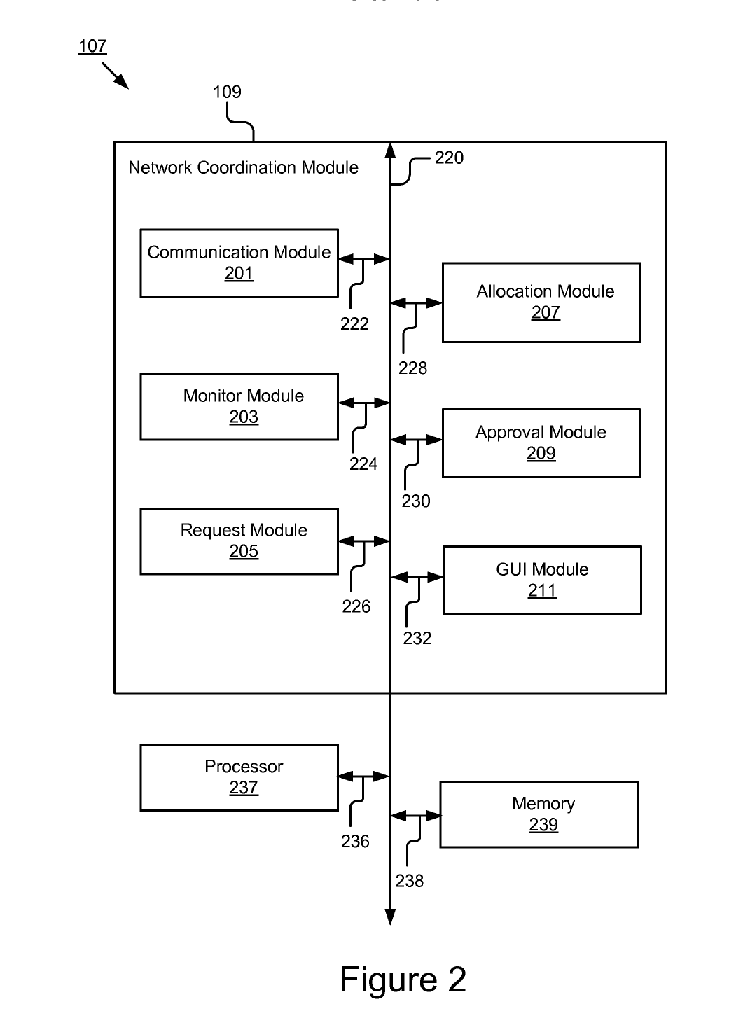

In the illustrated embodiment, the connection unit 107a includes a network coordination module 109a. The network coordination module 109a is code and routines for managing time slots for data communication. In one embodiment, the data communication is implemented using a time-division-multiple-access (TDMA)-based medium access control protocol. In one embodiment, the network coordination module 109a includes code and routines stored in an on-chip storage (not pictured) of a processor (not pictured) comprised within the connection unit 107a. In another embodiment, the network coordination module 109a is implemented using hardware such as a field-programmable gate array (FPGA) or an application-specific integrated circuit (ASIC). In yet another embodiment, the network coordination module 109a is implemented using a combination of hardware and software. The network coordination module 109a is described below in more detail with reference to FIGS. 2-7B.

The network systems 101b and 101n have similar structures and functionality as the network system 101a. Like reference numerals are used to refer to similar elements and the descriptions for the similar elements will not be repeated here. In one embodiment, the network systems 101a, 101b . . . 101n are comprised within an in-vehicle network.

In the illustrated embodiment, the network system 101b includes a node 103c, a node 103d and a connection unit 107b. The connection unit 107b includes a network coordination module 109b. The node 103c is communicatively coupled to the connection unit 107b via signal line 124. The node 103d is communicatively coupled to the connection unit 107b via signal line 126. One skilled in the art will recognize that the network system 101b may include any number of nodes 103. The network system 101n includes a node 103e, a node 103f and a connection unit 107n. The connection unit 107n includes a network coordination module 109n. The node 103e is communicatively coupled to the connection unit 107n via signal line 128. The node 103f is communicatively coupled to the connection unit 107n via signal line 130. One skilled in the art will recognize that the network system 101n may include any number of nodes 103.

In one embodiment, the network systems 101a, 101b . . . 101n share a common channel for communicating data with each other. For example, nodes 103 comprised within a network system 101 communicate with other nodes 103 comprised within other network systems 101 using a common channel. In another embodiment, the network systems 101a, 101b . . . 101n share a common channel for communicating data with the switch unit 113. For example, nodes 103 comprised within different network systems 101a, 101b . . . 101n communicate with the switch unit 113 using a common channel. In yet another embodiment, the network systems 101a, 101b . . . 101n share a common channel for communicating data with one or more subsystems 115a, 115b . . . 115n. In one embodiment, a common channel is a wireless communication channel operating at the same radio frequency for the network systems 101a, 101b . . . 101n.

In one embodiment, the network systems 101a, 101b . . . 101n communicate with each other directly without involving the switch unit 113. For example, a node 103 comprised within a network system 101 directly communicates with another node 103 comprised within another network system 101 using a wireless communication channel. In another embodiment, a network system 101a, 101b . . . 101n communicates with one or more subsystems 115 directly without involving the switch unit 103. For example, a node 103 comprised within a network system 101 directly communicates with the one or more subsystems 115 using a wireless communication channel.

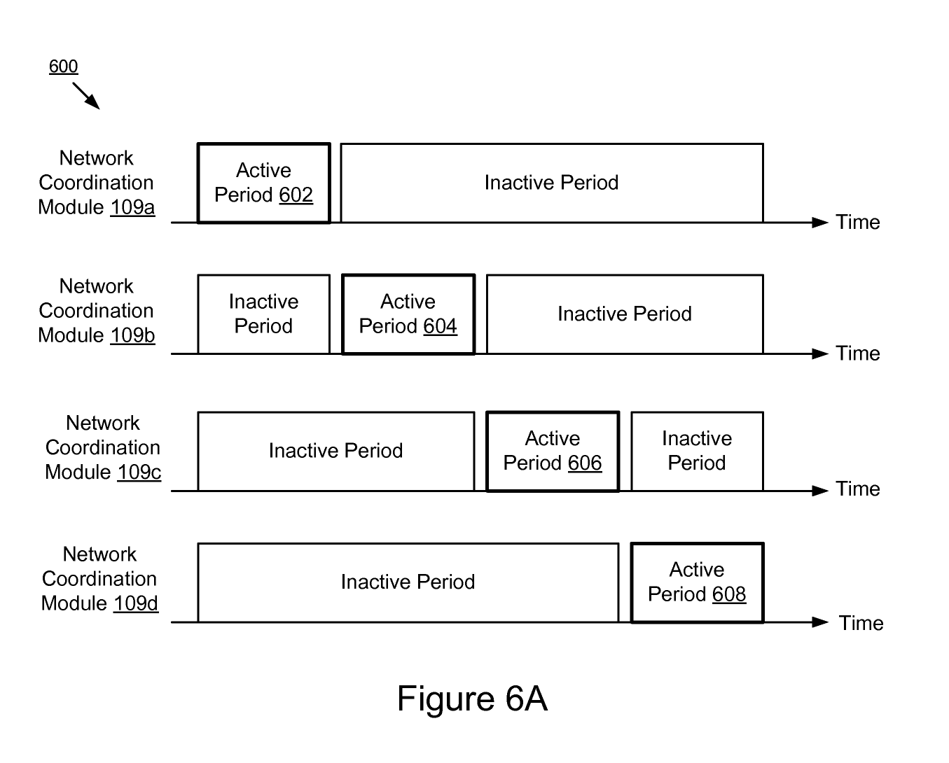

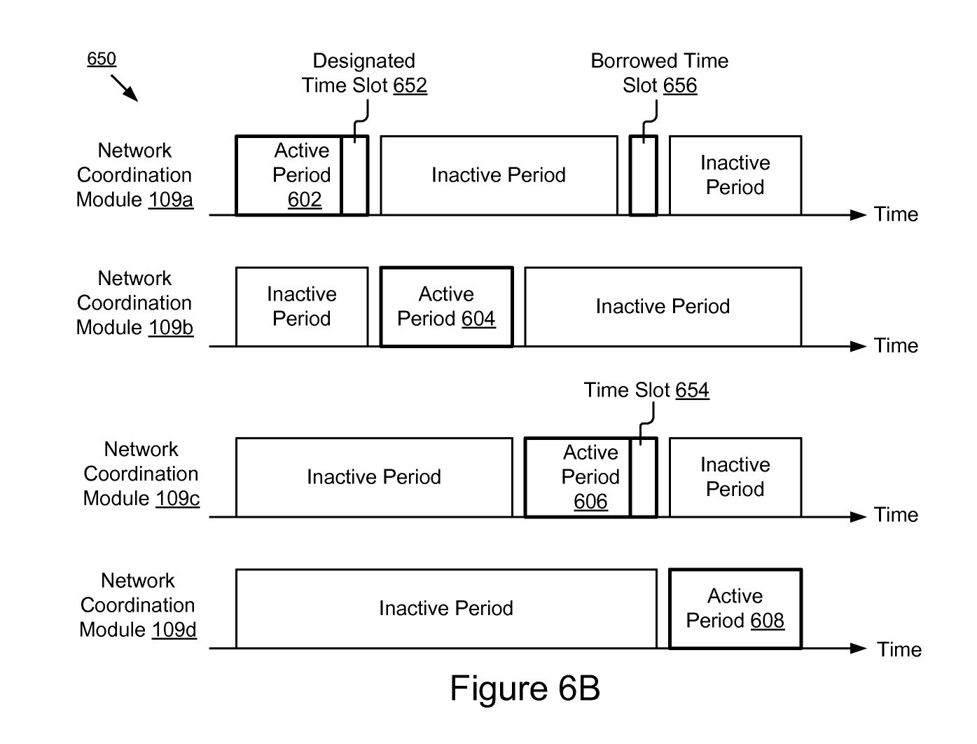

An active period is a period of time designated to a network system 101 for data transmission. For example, an active period for a network system 101 is a period of time during which nodes 103 comprised within the network system 101 are allowed to transmit data. The nodes 103 are not allowed to transmit data during the inactive period for the network system 101. An inactive period for a network system 101 is a period of time not designated to the network system 101 for data transmission. For example, an inactive period for a network system 101 is a period of time during which nodes 103 comprised within the network system 101 are not allowed to transmit data. In one embodiment, an active period for a first network system 101 is an inactive period for a second network system 101. Examples of an active period and inactive period for a network system 101 are illustrated in FIG. 6A. An active period for a network system 101 is also referred to as a designated active period for the network system 101.

In one embodiment, an active period includes one or more time slots. A time slot is a time duration comprising a fraction of an active period. A time slot included in an active period designated for a network system 101 is also referred to as a designated time slot for the network system 101.

To avoid collision and/or interference among different network systems 101a, 101b . . . 101n that share a common channel for data communication, each of the network systems 101a, 101b . . . 101n is designated with a non-overlapped active period for data transmission. For example, a first network system 101 is designated with a first active period. The network coordination module 109 allocates one or more designated time slots included in the first active period to one or more nodes 103 comprised within the first network system 101, allowing the one or more nodes 103 to transmit data during the designated time slots. Similarly, a second network system 101 is designated with a second active period, allowing one or more nodes 103 comprised within the second network system 101 to transmit data during the second active period. Since the first active period is not overlapped with the second active period, no interference and/or collision between the first network system 101 and the second network system 101 is incurred during the data transmission.

In one embodiment, a first network system 101 associated with a first active period borrows one or more time slots from a second active period designated for a second network system 101 as described below in more detail with reference to FIGS. 2-7B. The second network system 101 reserves the one or more borrowed time slots for the first network system 101, allowing nodes 103 comprised within the first network system 101 to transmit data during the first active period designated for the first network system 101 and the borrowed time slots included in the second active period.

The switch unit 113 is a device for routing data between different entities of the system 100. For example, the switch unit 113 routes data between a network system 101 and a network 105. In one embodiment, the switch unit 113 routes data between a network system 101 and a subsystem 115. In another embodiment, the switch unit 113 routes data between a first network system 101 and a second network system 101. In yet another embodiment, the switch unit 113 routes data between a first subsystem 115 and a second subsystem 115.

The subsystem 115 is a system for providing any functionality available in a vehicle. For example, the subsystem 115 is one of a safety system (e.g., an airbag monitoring system, an engine monitoring system, etc.), an information-providing system (e.g., a global positioning system) and an entertainment system (e.g., a stereo system), etc. One skilled in the art will recognize that other types of subsystems 115 are possible. In one embodiment, the subsystem 115 includes one or more network systems 101 each comprising one or more nodes 103. In another embodiment, the subsystem 115 is comprised within an in-vehicle network.

The optional network 105 is a conventional type of network, wired or wireless, and may have any number of configurations such as a star configuration, token ring configuration or other configurations known to those skilled in the art. In one embodiment, the network 105 comprises one or more of a local area network (LAN), a wide area network (WAN) (e.g., the Internet) and/or any other interconnected data path across which multiple devices communicate. In another embodiment, the network 105 is a peer-to-peer network. The network 105 is coupled to or includes portions of a telecommunications network for sending data in a variety of different communication protocols. For example, the network is a 3G network or a 4G network. In yet another embodiment, the network 105 includes Bluetooth communication networks or a cellular communications network for sending and receiving data such as via short messaging service (SMS), multimedia messaging service (MMS), hypertext transfer protocol (HTTP), direct data connection, wireless application protocol (WAP), email, etc. In yet another embodiment, all or some of the links in the network 105 are encrypted using conventional encryption technologies such as secure sockets layer (SSL), secure HTTP and/or virtual private networks (VPNs).

The optional unified cloud database 117 is an online database accessible via the network 105. For example, the unified cloud database 117 is a database where data is stored on multiple virtual servers hosted by different companies. In one embodiment, the unified cloud database 117 stores any data for providing the functionality of the system 100. In another embodiment, the unified cloud database 117 stores data received from a plurality of network systems 101 and/or subsystems 115 embedded in a plurality of vehicles.

The system 100 is particularly beneficial under one or more of the following circumstances: (1) multiple network systems 101 (e.g., ten network systems 101) share a common channel for data transmission; (2) each network system 101 includes a plurality of nodes 103 (e.g., each network system 101 includes more than twenty nodes 103 to transmit data which may result in congested traffic); (3) a transmission rate that is higher than the rate achieved by only using a designated active period is requested; and (4) nodes 103 comprised within a network system 101 request to transmit data outside the active period designated for the network system 101. As described below in more detail, the system 100 allows a network coordination module 109 in a network system 101 to borrow available time slots for data transmission from other network coordination modules 109 in other network systems 101. Therefore, the network system 101 is able to extend its active period for data transmission while avoiding collisions among the different network systems 101 sharing the same channel.

### Network Coordination Module

Referring now to FIG. 2, the network coordination module 109 is shown in more detail. FIG. 2 is a diagram illustrating a connection unit 107 according to one embodiment. In the illustrated embodiment, the connection unit 107 includes a processor 237, a memory 239 and a network coordination module 109. These components of the connection unit 107 are communicatively coupled to each other via a bus 220. The processor 237 is communicatively coupled to the bus 220 via signal line 236. The memory 239 is communicatively coupled to the bus 220 via signal line 238.

The processor 237 comprises an arithmetic logic unit, a microprocessor, a general purpose controller or some other processor array to perform computations, retrieve data stored on the memory 239, etc. The processor 237 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible.

The memory 239 stores instructions and/or data that may be executed by the processor 237. The instructions and/or data may comprise code for performing any and/or all of the techniques described herein. The memory 239 may be a dynamic random access memory (DRAM) device, a static random access memory (SRAM) device, flash memory or some other memory device known in the art. In one embodiment, the memory 239 also includes a non- volatile memory or similar permanent storage device and media such as a hard disk drive, a floppy disk drive, a CD-ROM device, a DVD-ROM device, a DVD-RAM device, a DVD-RW device, a flash memory device, or some other mass storage device known in the art for storing information on a more permanent basis.

In the illustrated embodiment, the network coordination module 109 includes a communication module 201, a monitor module 203, a request module 205, an allocation module 207, an approval module 209 and a graphical user interface (GUI) module 211. These components are communicatively coupled to each other via the bus 220.

The communication module 201 is code and routines that, when executed by the processor 237, handles communication between components of the network coordination module 109 and other components of the system 100. For example, the communication module 201 comprised within a network coordination module 109 receives a borrowing request from the request module 205 and sends the borrowing request to another network coordination module 109. A borrowing request is a request to borrow one or more time slots from other network systems 101 for data transmission.

In one embodiment, the communication module 201 handles communication among components of the network coordination module 109. For example, the communication module 201 receives event data describing a trigger event from the monitor module 203 and sends the event data to the request module 205. The trigger event is described below in more detail. One skilled in the art will recognize that the communication module 201 may provide any functionality described herein. The communication module 201 is communicatively coupled to the bus 220 via signal line 222.

The monitor module 203 is code and routines that, when executed by the processor 237, monitors for occurrence of any trigger event associated with a network system 101. The monitor module 203 is communicatively coupled to the bus 220 via signal line 224. In one embodiment, the monitor module 203 monitors one or more nodes 103 comprised within the network system 101 for occurrences of any trigger event. If the monitor module 203 detects a trigger event occurring in the network system 101, the monitor module 203 sends event data describing the trigger event to the request module 205.

A trigger event is an event triggering a request to borrow one or more time slots from other network systems 101. For example, a trigger event is one of a congestion for data transmission in one or more nodes 103 comprised within a network system 101, available storage space in one or more data buffers (not pictured) comprised within the network system 101 falling below a predetermined threshold, a request to transmit data outside a designated active period of the network system 101 and an instruction to improve transmission performance (e.g., a request to transmit data in a higher transmission rate, shorter delays and/or lower data loss, etc.). One skilled in the art will recognize that other types of trigger events are possible.

The request module 205 is code and routines that, when executed by the processor 237, generates a borrowing request. The request module 205 is communicatively coupled to the bus 220 via signal line 226. In one embodiment, a borrowing request includes data describing an initiator, a potential lender and an indication to borrow time slots. An initiator is an entity that initiates a borrowing request. For example, an initiator is a network coordination module 109 comprised within a network system 101 that requests to borrow one or more time slots from other network systems 101. A potential lender is an entity that determines whether to lend one or more time slots to an initiator. For example, a potential lender is a network coordination module 109 that processes a borrowing request received from an initiator and determines whether to lend one or more time slots to the initiator. In one embodiment, an initiator and a potential lender are network coordination modules 109 sharing a common channel for data transmission.

In one embodiment, the request module 205 comprised within a network system 101 receives event data describing a trigger event from the monitor module 203. The request module 205 generates a borrowing request to borrow one or more time slots from a potential lender responsive to the trigger event. The request module 205 sends the borrowing request to the potential lender. In another embodiment, the request module 205 generates a plurality of borrowing requests responsive to the trigger event and sends the plurality of borrowing requests to a plurality of potential lenders. For example, the request module 205 generates a borrowing request for each of the plurality of potential lenders and sends the borrowing request to each of the plurality of potential lenders.

The allocation module 207 is code and routines that, when executed by the processor 237, allocates time slots to one or more nodes 103 for data communication. The allocation module 207 is communicatively coupled to the bus 220 via signal line 228. In one embodiment, the allocation module 207 allocates one or more designated time slots included in the active period of the network system 101 to one or more nodes 103 comprised within the network system 101. For example, the allocation module 207 allocates a first time slot in the active period to a first node 103, allowing the first node 103 to transmit data during the first time slot. Similarly, the allocation module 207 allocates a second time slot in the active period to a second node 103, allowing the second node 103 to transmit data during the second time slot.

In one embodiment, the allocation module 207 receives a response from a potential lender. A response includes answer data responding to a borrowing request. For example, a response is one of an approval response and a disapproval response. A disapproval response is a response from a potential lender that refuses to lend any time slot to the initiator. In one embodiment, a disapproval response includes data describing one or more of a potential lender that has disapproved the borrowing request, an initiator that has initiated the borrowing request and an indication of disapproval.

An approval response is a response from a potential lender that authorizes to lend one or more time slots to an initiator. In one embodiment, an approval response includes data describing one or more of a potential lender that has approved the borrowing request, an initiator that has initiated the borrowing request, an indication of approval, one or more time slot identifiers (IDs) for the one or more time slots lent to the initiator and a specified lending period of time. A specified lending period of time is a period of time during which a potential lender agrees to lend one or more time slots to an initiator. For example, the specified lending period of time is a duration of two minutes counting from the time when the potential lender approves the borrowing request. In one embodiment, the specified period of time is determined by the potential lender. The one or more time slots lent to the initiator is also referred to as one or more borrowed time slots for the initiator.

In one embodiment, the allocation module 207 determines whether the borrowing request has been approved by the potential lender based at least in part on the received response. For example, the allocation module 207 determines whether the response is an approval response or a disapproval response. If the response is a disapproval response, the allocation module 207 determines that the borrowing request has been denied by the potential lender. The allocation module 207 only allocates designated time slots included in the designated active period to one or more nodes 103 for data transmission.

If the response is an approval response, the allocation module 207 determines that the borrowing request has been approved by the potential lender. The allocation module 207 extracts one or more time slot IDs identifying one or more borrowed time slots from the approval response. In one embodiment, the allocation module 207 extends the active period for the network system 101 to include the designated active period and the one or more borrowed time slots. The active period including the designated active period and the one or more borrowed time slots is referred to as an extended active period.

The allocation module 207 allocates time slots included in the extended active period to one or more nodes 103 for data transmission. For example, the allocation module 207 allocates the designated time slots and the one or more borrowed time slots to the one or more nodes 103, allowing the one or more nodes 103 to transmit data during the designated time slots and the one or more borrowed time slots. In one embodiment, the allocation module 207 allocates the one or more borrowed time slots to the one or more nodes 103 only during the specified lending period of time. If the specified lending period of time has passed, the allocation module 207 does not allocate the borrowed time slots to the nodes 103. Instead, the allocation module 207 instructs the request module 205 to generate a new borrowing request and send the new borrowing request to the potential lender for approval.

In one embodiment, the allocation module 207 receives a plurality of responses from a plurality of potential lenders. For example, the allocation module 207 receives a response from each of the plurality of potential lenders. The allocation module 207 determines whether there are any approval responses in the plurality of responses. If there is no approval response included in the plurality of responses, the allocation module 207 determines that none of the potential lenders approves to lend any time slots to the initiator. The allocation module 207 only allocates designated time slots included in the active period designated for the network system 101 to the one or more nodes 103 for data transmission.

If there are one or more approval responses included in the plurality of responses, the allocation module 207 extracts one or more time slot IDs from each of the one or more approval responses. The allocation module 207 extends the active period to include the designated active period for the network system 101 and all the borrowed time slots identified by the time slot IDs included in the one or more approval responses. The allocation module 207 allocates the time slots included in the extended active period (e.g., the designated time slots included in the designated active period and all the borrowed time slots from other network systems 101) to the one or more nodes 103 for data transmission.

It is particularly advantageous for a network system 101 (e.g., an initiator) to extend its active period to include a designated active period for the network system 101 and one or more borrowed time slots from one or more other network systems 101 (e.g., potential lenders). For example, one or more nodes 103 comprised within the network system 101 now transmit data not only using the designated active period associated with the network system 101 but also using the one or more borrowed time slots from other network systems 101. Various performance improvements for the network system 101 such as an increased throughput, a reduced delay and/or a decreased data loss are achieved due to the borrowing of time slots.

The approval module 209 is code and routines that, when executed by the processor 237, determines whether to approve lending one or more time slots from a designated active period to an initiator. The approval module 209 is communicatively coupled to the bus 220 via signal line 230. In one embodiment, the approval module 209 receives a borrowing request from an initiator and determines whether there is any time slot available for lending to the initiator. For example, the approval module 209 determines whether there is any idle time slot in the active period designated for the network system 101.

If there are one or more time slots available for lending to the initiator, the approval module 209 approves the lending of the one or more available time slots to the initiator. In one embodiment, the approval module 209 reserves the one or more time slots for the initiator. For example, the approval module 209 instructs the allocation module 207 not to allocate the reserved time slots to any node 103 comprised within the same network system 101. In one embodiment, the approval module 209 approves to lend the one or more available time slots to the initiator in a specified lending period of time. The approval module 209 generates an approval response including one or more of time slot IDs identifying the reserved time slots and the specified lending period of time. The approval module 209 sends the approval response to the initiator. In one embodiment, when the specified lending period of time (e.g., five minutes) has passed, the approval module 209 stops reserving the available time slots to the initiator.

If there is no time slot available for lending to the initiator (e.g., all the designated time slots for the network system 101 are allocated and/or anticipated to be allocated to nodes 103 for data transmission, or the designated time slots are lent out to other initiators, etc.), the approval module 209 refuses to lend any time slot to the initiator. The approval module 209 generates a disapproval response indicating the disapproval of lending any time slots and sends the disapproval response to the initiator.

In one embodiment, the approval module 209 receives a plurality of borrowing requests from a plurality of initiators. For example, the approval module 209 receives a borrowing request from each initiator. In one embodiment, the approval module 209 prioritizes the plurality of borrowing requests. For example, the approval module 209 orders the plurality of borrowing requests based at least in part on the received time of each borrowing request. The approval module 209 processes each borrowing request based at least in part on the ordering and determines whether to lend one or more time slots to the respective initiator by performing operations similar to those described above. For example, the approval module 209 selects the borrowing request with the earliest received time and determines whether to approve lending one or more time slots to the initiator generating the earliest borrowing request. Next, the approval module 209 selects the borrowing request having the second earliest received time and determines whether to lend one or more time slots to the initiator generating the second earliest borrowing request.

The GUI module 211 is code and routines that, when executed by the processor 237, generates graphical data for providing a GUI to a user. The GUI module 211 is communicatively coupled to the bus 220 via signal line 232. The GUI module 211 sends the graphical data to a display (not pictured) comprised within the network system 101, causing the display to present a GUI to a user based at least in part on the graphical data.

In one embodiment, the GUI module 211 receives one or more time slot IDs identifying one or more time slots lent to an initiator from the approval module 209. The GUI module 211 generates graphical data for providing a GUI to notify an administrator of the one or more time slots lent to the initiator. In another embodiment, the GUI module 211 receives event data describing a trigger event from the monitor module 203. The GUI module 211 generates graphical data for providing a GUI to notify the administrator of the trigger event. One skilled in the art will recognize that the GUI module 211 may provide other functionality described herein.

### Event Diagram

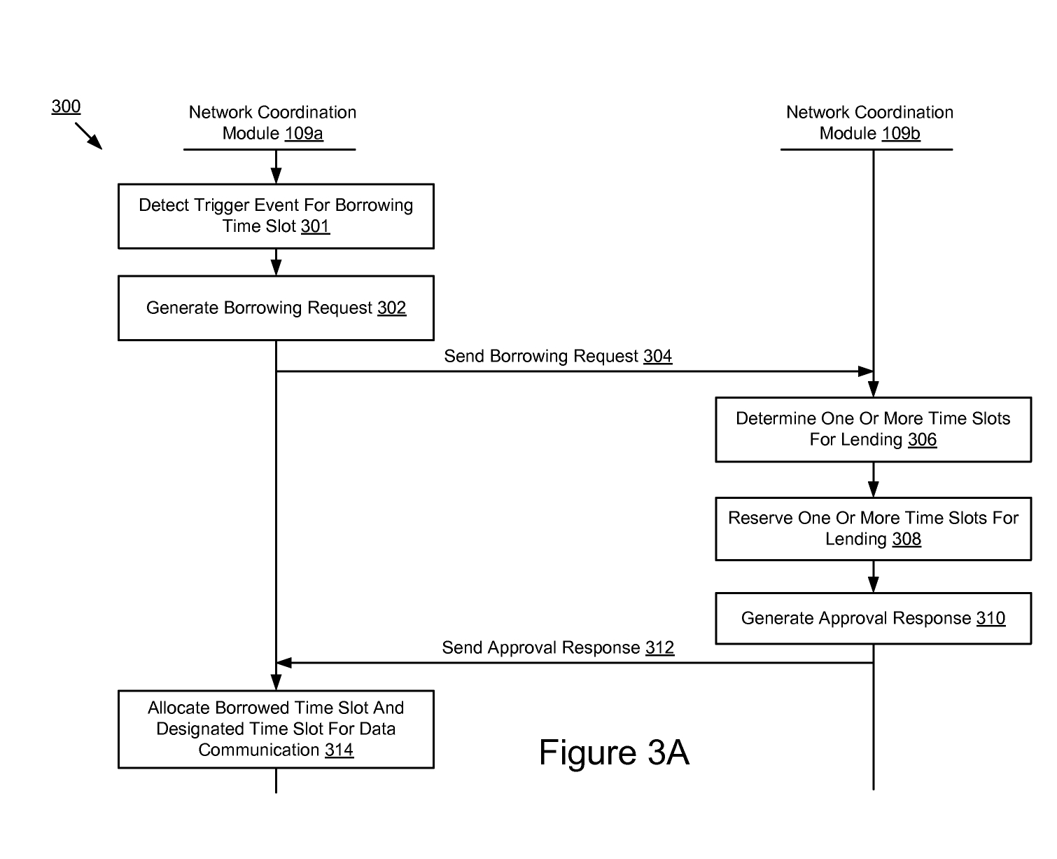

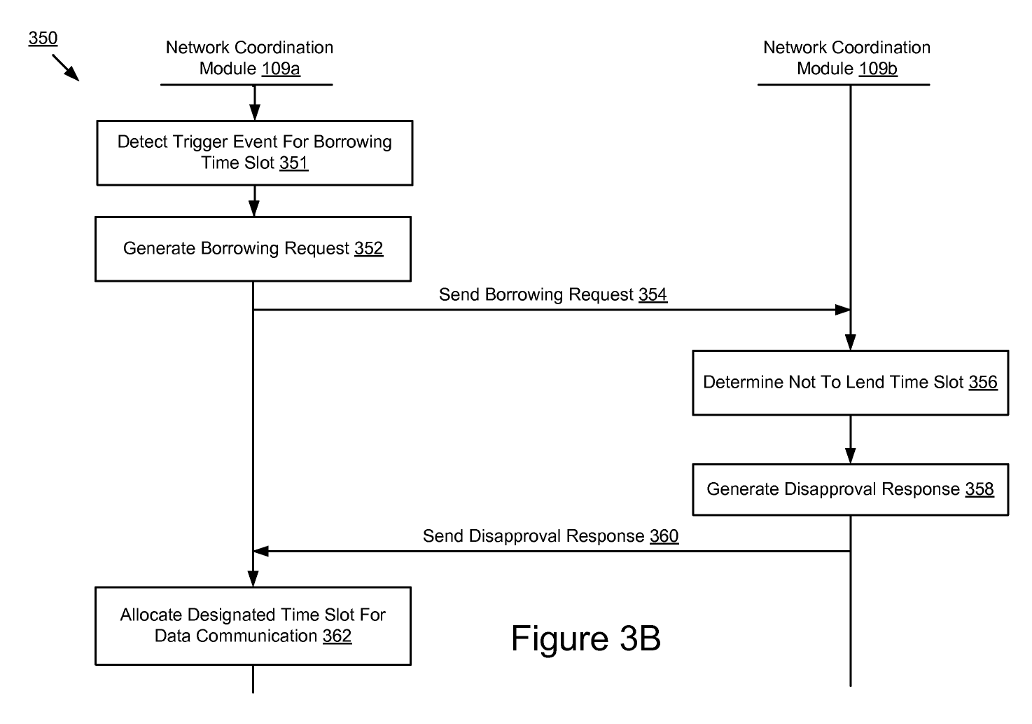

FIG. 3A is an event diagram 300 illustrating a process for managing time slots for data communication according to one embodiment. In the illustrated embodiment, a first network coordination module 109a (referred to as an initiator) requests to borrow one or more time slots from a second network coordination module 109b (referred to as a potential lender). The first network coordination module 109a is comprised within a first network system 101a. The second network coordination module 109b is comprised within a second network system 101b. The first network system 101a and the second network system 101b share a common channel for data transmission to other entities shown in FIG. 1. The first network system 101a is designated with a first active period for data transmission. The second network system 101b is designated with a second active period for data transmission. The first active period is not overlapped with the second active period.

The monitor module 203 comprised within the first network coordination module 109a detects 301 a trigger event for borrowing one or more time slots. The monitor module 203 sends event data describing the trigger event to the request module 205 comprised within the first network coordination module 109a. The request module 205 generates 302 a borrowing request responsive to the trigger event. The request module 205 sends the borrowing request to a first communication module 201 comprised within the first network coordination module 109a.

The first communication module 201 sends 304 the borrowing request to a second communication module 201 comprised within the second network coordination module 109b. The second communication module 201 sends the borrowing request to the approval module 209 comprised within the second network coordination module 109b. The approval module 209 determines 306 to lend one or more time slots from the second active period to the first network coordination module 109a. For example, the approval module 209 determines that there are one or more idle time slots in the second active period available for lending, and approves to lend the one or more idle time slots to the first network coordination module 109a.

The approval module 209 reserves 308 the one or more available time slots for lending to the first network coordination module 109a. The approval module 209 generates 310 an approval response and sends the approval response to the second communication module 201. The approval response includes, among other things, one or more time slot IDs identifying one or more time slots approved for lending to the first Network system 101a and a specified lending period of time, etc.

The second communication module 201 sends 312 the approval response to the first communication module 201. The first communication module 201 sends the approval response to the allocation module 207 comprised within the first network coordination module 109a. The allocation module 207 extracts one or more time slot IDs identifying one or more borrowed time slots from the approval response. The allocation module 207 allocates 314 the one or more borrowed time slots included in the second active period and the designated time slots included in the first active period to one or more nodes 103 comprised within the first network system 101a for data transmission.

FIG. 3B is an event diagram 350 illustrating a process for managing time slots for data communication according to another embodiment. As described above with reference to FIG. 3A, a first network coordination module 109a comprised within a first network system 101a requests to borrow one or more time slots from a second network coordination module 109b comprised within a second network system 101b. The first network system 101a is designated with a first active period and the second network system 101b is designated with a second active period for data transmission. The first network system 101a and the second network system 101b share a common channel for data transmission to other entities shown in FIG. 1.

The monitor module 203 comprised within the first network coordination module 109a detects 351 a trigger event for borrowing one or more time slots. The monitor module 203 sends event data describing the trigger event to the request module 205 comprised within the first network coordination module 109a. The request module 205 generates 352 a borrowing request responsive to the trigger event. The request module 205 sends the borrowing request to a first communication module 201 comprised within the first network coordination module 109a.

The first communication module 201 sends 354 the borrowing request to a second communication module 201 comprised within the second network coordination module 109b. The second communication module 201 sends the borrowing request to the approval module 209 comprised within the second network coordination module 109b. The approval module 209 determines 356 not to lend any time slot from the second active period to the first network coordination module 109a. For example, the approval module 209 determines that all the time slots included in the second active period are occupied for data transmission by one or more nodes 103 and therefore determines not to lend any time slot to the first network coordination module 109a.

The approval module 209 generates 358 a disapproval response and sends the disapproval response to the second communication module 201. The second communication module 201 sends 360 the disapproval response to the first communication module 201. The first communication module 201 sends the disapproval response to the allocation module 207 comprised within the first network coordination module 109a. The allocation module 207 determines that the borrowing request has been denied by the second network coordination module 109b. The allocation module 207 allocates 362 the designated time slots included in the first active period to one or more nodes 103 comprised within the first network system 101a for data transmission.

### Methods

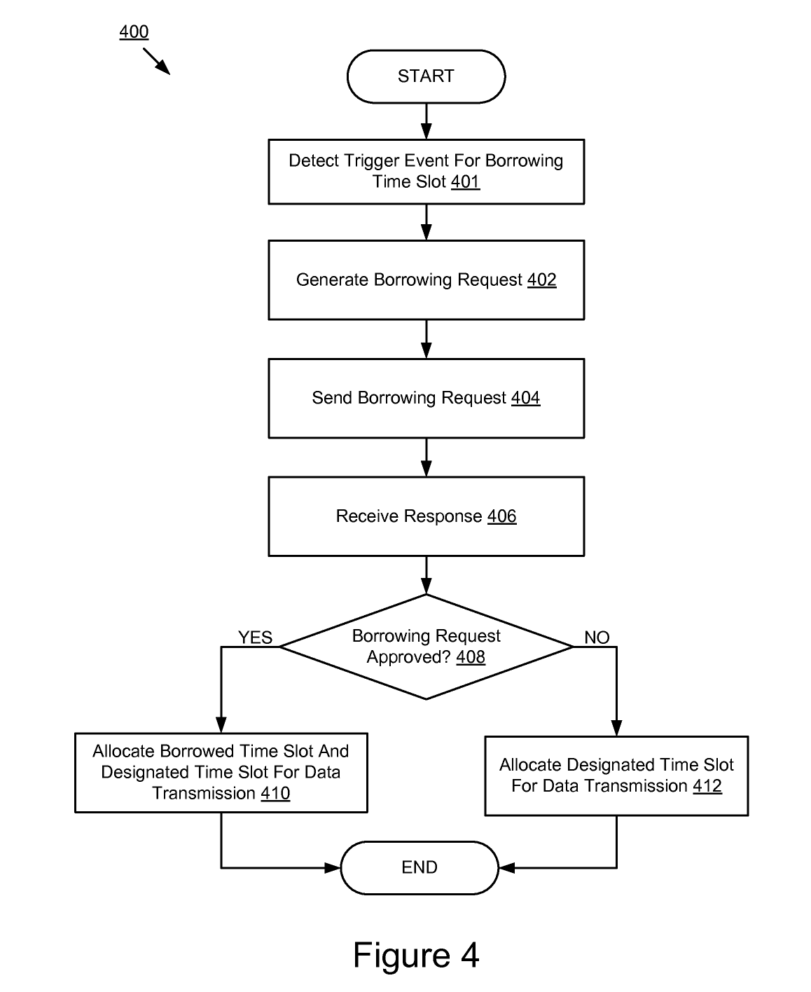

FIG. 4 is a flowchart illustrating a method 400 for borrowing one or more time slots according to one embodiment. In the illustrated embodiment, a network coordination module 109a (also referred to as an initiator) requests to borrow one or more time slots from another coordination module 109b (also referred to as a potential lender). The monitor module 203 comprised within the initiator detects 401 a trigger event for borrowing one or more time slots. The monitor module 203 sends event data describing the trigger event to the request module 205 comprised within the initiator. The request module 205 generates 402 a borrowing request in response to receiving the trigger event. The request module 205 sends the borrowing request to the communication module 201 comprised within the initiator. The communication module 201 sends 404 the borrowing request to the potential lender.

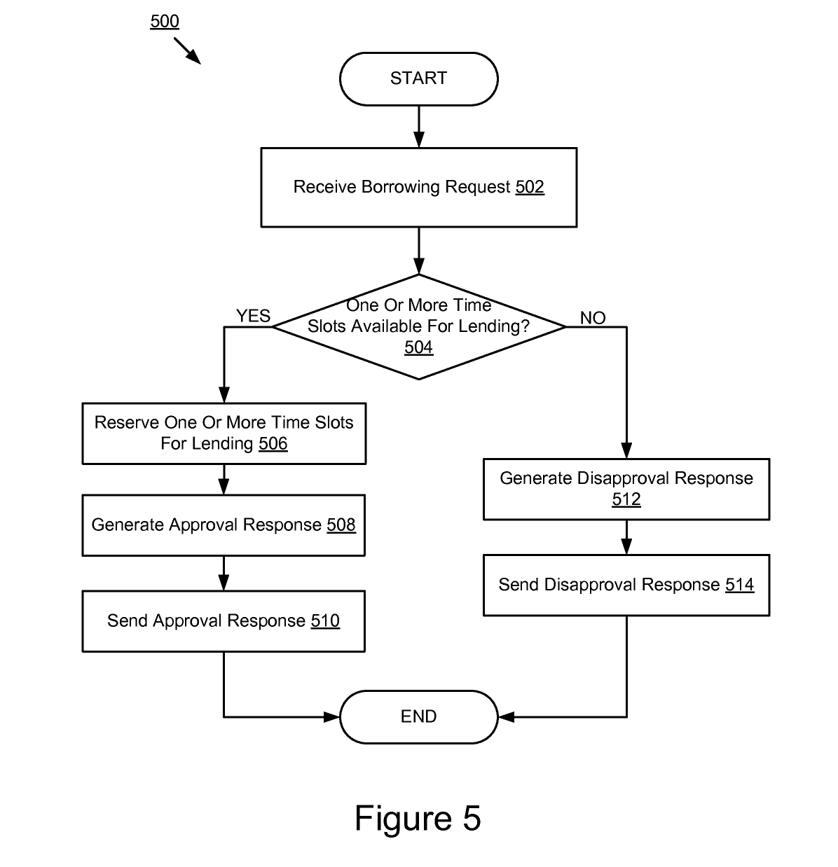

The approval module 209 comprised within the potential lender determines whether to lend one or more time slots to the initiator and generates a response based at least in part on the determination. For example, the approval module 209 performs steps similar to those described below with reference to FIG. 5 and generates a response responsive to receiving the borrowing request from the initiator. The approval module 209 sends the response to the communication module 201 comprised within the initiator.

The communication module 201 receives 406 the response from the potential lender and sends the response to the allocation module 207 comprised within the initiator. The allocation module 207 determines 408 whether the borrowing request is approved by the potential lender. For example, the allocation module 207 determines whether the response is an approval response or a disapproval response. An approval response indicates that the potential lender has approved the borrowing request. For example, an approval response includes, among other things, one or more time slot IDs identifying one or more time slots lent to the initiator. A disapproval response indicates that the potential lender has denied the borrowing request. If the borrowing request is approved by the potential lender, the method 400 moves to step 410. Otherwise, the method 400 moves to step 412.

At step 410, the allocation module 207 allocates one or more time slots borrowed from the potential lender and one or more time slots designated to the initiator to one or more nodes 103 for data transmission. The one or more designated time slots are time slots included in a first active period designated to the initiator. The one or more borrowed time slots are time slots included in a second active period designated to the potential lender. The first active period is not overlapped with the second active period.

Turning to step 412, the allocation module 207 only allocates one or more designated time slots associated with the initiator to one or more nodes 103 for data transmission. The method 400 ends.

FIG. 5 is a flowchart illustrating a method 500 for determining whether to lend one or more time slots to an initiator according to one embodiment. In the illustrated embodiment, a network coordination module 109a (also referred to as an initiator) requests to borrow one or more time slots from another coordination module 109b (also referred to as a potential lender). The potential lender determines whether to lend one or more time slots to the initiator. The communication module 201 comprised within the potential lender receives 502 a borrowing request from the initiator. The communication module 201 sends the borrowing request to the approval module 209 comprised within the potential lender.

The approval module 209 determines 504 whether there are one or more time slots available for lending to the initiator. For example, the approval module 209 determines whether there is any idle time slot not used for data transmission and not lent to any other network coordination module 109. If there are one or more time slots available for lending, the method 500 moves to step 506. Otherwise, the method 500 moves to step 512.

At step 506, the approval module 209 reserves one or more available time slots for lending to the initiator. The approval module 209 generates 508 an approval response including one or more time slot IDs identifying the one or more reserved time slots. The approval module 209 sends 510 the approval response to the initiator.

At step 512, the approval module 209 generates a disapproval response including an indication of refusing to lend any time slot to the initiator. The approval module 209 sends 514 the disapproval response to the initiator. The method 500 ends.

### Graphical Representations

FIG. 6A is a graphical representation illustrating a process 600 for managing time slots for data communication according to one embodiment. In the illustrated embodiment, a first network coordination module 109a, a second network coordination module 109b, a third network coordination module 109c and a fourth network coordination module 109d share a common channel for data communication with each other and/or other entities shown in FIG. 1. The first network coordination module 109a is designated with a first active period 602, allowing one or more nodes 103 associated with the first network coordination module 109a to transmit data during the first active period 602. Similarly, the second network coordination module 109b is designated with a second active period 604. The third network coordination module 109c is designated with a third active period 606. The fourth network coordination module 109d is designated with a fourth active period 608. The active periods 602, 604, 606 and 608 are not overlapped as shown in FIG. 6A. FIG. 6A also illustrates inactive periods for each of the network coordination modules 109a, 109b, 109c and 109d.

FIG. 6B is a graphical representation illustrating a process 650 for managing time slots for data communication according to another embodiment. As described above with reference to FIG. 6A, each of the network coordination modules 109a, 109b, 109c and 109d is designated with a non-overlapped active period. In one embodiment, the monitor module 203 comprised within the network coordination module 109a detects a trigger event for borrowing one or more time slots. The request module 205 comprised within the network coordination module 109a generates one or more borrowing requests and sends the borrowing requests to one or more of the network coordination modules 109b, 109c and 109d.

In the illustrated embodiment, the network coordination modules 109b and 109d disapprove the borrowing request and determine not to lend any time slot to the network coordination module 109a, respectively. The network coordination module 109c approves to lend a time slot 654 from its associated active period 606 to the network coordination module 109a. After the approval of lending, the time slot 654 associated with the network coordination module 109c is also referred to as a borrowed time slot 656 for the network coordination module 109a. In one embodiment, the network coordination module 109a allocates a designated time slot 652 included in the active period 602 and the borrowed time slot 656 (or, the time slot 654) included in the active period 606 to a node 103 associated with the network coordination module 109a for data transmission. In the illustrated embodiment, the network coordination module 109a extends the active period to include the active period 602 and the borrowed time slot 656.

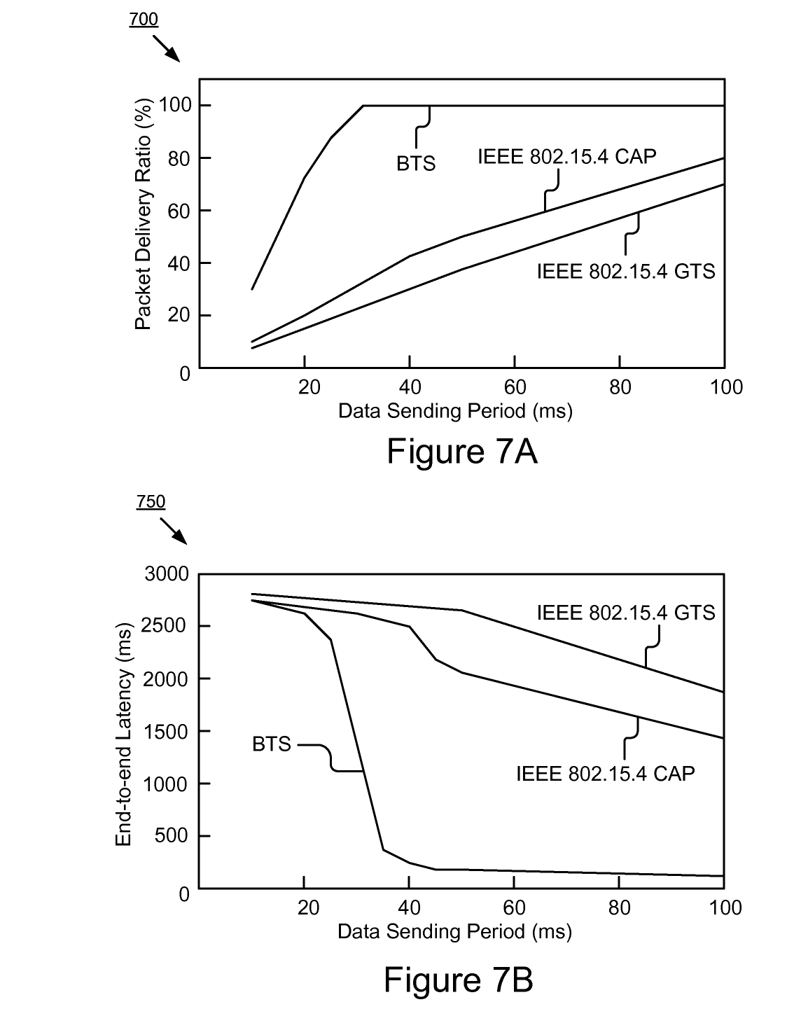

FIG. 7A is a graphical representation 700 illustrating a performance for a time-slot management according to one embodiment. The techniques described in the specification are applied to the IEEE 802.15.4 protocol for performance evaluation. In one embodiment, the IEEE 802.15.4 protocol uses a TDMA-based scheme in the contention-free period (CFP) of the superframe so that the transmission time is divided into guaranteed time slots (GTS). The guaranteed time slots are allocated to nodes 103 to transmit data. However, the system 100 is more advantageous over the IEEE 802.15.4 protocol because, for example, the system 100 allows a network coordination module 109 to borrow available guaranteed time slots from other network coordination modules 109 for data transmission as described above with reference to FIGS. 2-6B.

FIG. 7A shows an example of a simulation result for the system 100 in terms of the packet delivery ratio versus data sending period. The simulation result demonstrates that the system 100 systematically improves the packet delivery ratio. For example, the system 100 (shown as “borrowed time slot (BTS)” in FIG. 7A) provides a higher packet delivery ratio than other solutions such as the use of stock GTS (shown as “IEEE 802.15.4 GTS” in FIG. 7A) and/or contention access period (CAP) of the IEEE 802.15.4 protocol (shown as “IEEE 802.15.4 CAP” in FIG. 7A).

FIG. 7B is a graphical representation 750 illustrating a performance for a time-slot management according to another embodiment. FIG. 7B shows an example of a simulation result for the system 100 in terms of the end-to-end latency versus data sending period. The simulation result demonstrates that the system 100 systematically reduces the end-to-end latency. For example, the system 100 (shown as “BTS” in FIG. 7B) provides a lower end-to-end latency than other solutions such as the IEEE 802.15.4 CAP and the IEEE 802.15.4 GTS.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to implementation in any specific programming language, or for any specific operating system or environment. Accordingly, the disclosure is intended to be illustrative, but not limiting, of the scope of the specification, which is set forth in the following claims.

1. A method for borrowing time slots for data communication, the method comprising:
detecting a trigger event for borrowing a time slot from a potential lender;
generating a borrowing request responsive to the trigger event;
receiving a response responding to the borrowing request from the potential lender;
determining whether the borrowing request is approved based at least in part on the response; and
responsive to an approval of the borrowing request, allocating one or more designated time slots included in a first active period and the borrowed time slot included in a second active period for data communication.

2. The method of claim 1, wherein the data communication is implemented using a time-division-multiple-access (TDMA)-based medium access control protocol.

3. The method of claim 1, wherein the first active period is designated to a first network system associated with an initiator and the second active period is designated to a second network system associated with the potential lender.

4. The method of claim 3, wherein the first network system and the second network system share a common channel for data transmission.

5. The method of claim 4, wherein the common channel is a wireless channel operating at a common radio frequency for the first network system and the second network system.

6. The method of claim 3, wherein the borrowed time slot is reserved for the first network system for a specified lending period of time.

7. The method of claim 3, wherein the borrowed time slot and the one or more designated time slots are allocated to one or more nodes included in the first network system to transmit data.

8. A system for borrowing time slots for data communication, the system comprising:
a monitor module detecting a trigger event for borrowing a time slot from a potential lender;
a request module communicatively coupled to the monitor module, the request module generating a borrowing request responsive to the trigger event; and
an allocation module communicatively coupled to the request module, the allocation module receiving a response responding to the borrowing request from the potential lender and determining whether the borrowing request is approved based at least in part on the response, the allocation module allocating one or more designated time slots included in a first active period and the borrowed time slot included in a second active period for data communication responsive to an approval of the borrowing request.

9. The system of claim 8, wherein the data communication is implemented using a time-division-multiple-access (TDMA)-based medium access control protocol.

10. The system of claim 8, wherein the first active period is designated to a first network system associated with an initiator and the second active period is designated to a second network system associated with the potential lender.

11. The system of claim 10, wherein the first network system and the second network system share a common channel for data transmission.

12. The system of claim 11, wherein the common channel is a wireless channel operating at a common radio frequency for the first network system and the second network system.

13. The system of claim 10, wherein the borrowed time slot is reserved for the first network system for a specified lending period of time.

14. The system of claim 10, wherein the borrowed time slot and the one or more designated time slots are allocated to one or more nodes included in the first network system to transmit data.

15. A computer program product comprising a non-transitory computer readable medium encoding instructions that, in response to execution by a computing device, cause the computing device to perform operations comprising:
detecting a trigger event for borrowing a time slot from a potential lender;
generating a borrowing request responsive to the trigger event;
receiving a response responding to the borrowing request from the potential lender;
determining whether the borrowing request is approved based at least in part on the response; and
responsive to an approval of the borrowing request, allocating one or more designated time slots included in a first active period and the borrowed time slot included in a second active period for data communication.

16. The computer program product of claim 15, wherein the data communication is implemented using a time-division-multiple-access (TDMA)-based medium access control protocol.

17. The computer program product of claim 15, wherein the first active period is designated to a first network system associated with an initiator and the second active period is designated to a second network system associated with the potential lender.

18. The computer program product of claim 17, wherein the first network system and the second network system share a common channel for data transmission.

19. The computer program product of claim 18, wherein the common channel is a wireless channel operating at a common radio frequency for the first network system and the second network system.

20. The computer program product of claim 17, wherein the borrowed time slot is reserved for the first network system for a specified lending period of time.

21. The computer program product of claim 17, wherein the borrowed time slot and the one or more designated time slots are allocated to one or more nodes included in the first network system to transmit data.
